(19) United States
(12) Patent Application Publication
(10) Pub. No.: US 2006/0176461 A1
(43) Pub. Date: Aug. 10, 2006

(54) Projection optical system and exposure apparatus having the same

(75) Inventor: Yoshiyuki Sekine, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/349,897

(22) Filed: Feb. 9, 2006

(30) Foreign Application Priority Data
Feb. 9, 2005 (JP) 2005-033424

(51) Int. Cl. G03B 27/54

(52) U.S. Cl. 355/67; 355/53

(57) ABSTRACT

A projection optical system for projecting a pattern of a first object onto a second object. The projection optical system includes a field stop provided to an optical element in the projection optical system, which is closest to the second object. The field stop is provided for shielding the outside of a pattern projected area on the second object.

### BACKGROUND OF THE INVENTION

The present invention relates generally to a projection optical system and an exposure apparatus having the same, and more particularly, to a structure of an optical element in the projection optical system, which is closest to an object. The present invention is suitable, for example, for a projection optical system used for an immersion exposure apparatus for exposing an object through the projection optical system and a liquid (fluid) between the projection optical system and the object.

A projection exposure apparatus has been conventionally used to transfer a circuit pattern on a mask (or reticle) via a projection optical system onto a wafer, etc., and high-quality exposure at a high resolution has recently been increasingly demanded.

The immersion exposure has attracted attention as one means that satisfies this demand. See, for example, Japanese Patent Application, Publication No. 10-303114. The immersion exposure promotes the higher numerical aperture (“NA”) of the projection optical system by replacing a medium at the wafer side of the projection optical system with a liquid. The projection optical system has an NA=n·sin θ, where n is a refractive index of the medium, and the NA increases when the medium has a refractive index higher than the refractive index of air, i.e., n>1. As a result, the resolution R (R=k₁(λ/NA)) of the exposure apparatus defined by a process constant k₁ and a light source wavelength λ becomes small.

On the other hand, a line width control is needed to achieve the high-quality exposure. A long-range flare in the projection optical system is one of the factors that deteriorates the line width control. Flare (light) is, generally, the light without a diffraction light to image the mask pattern, and is a light that repeats multiple reflection in various places and reaches the wafer. The light from the mask pattern includes higher order diffraction lights such as second-order and third-order, etc., that do not contribute to imaging of a predetermined pattern. The higher order diffraction lights reflect at a lens circumference surface (also referred to as an “edge”) inside the projection optical system and a metal surface of a lens barrel inside surface, etc., and reach the wafer. Next, the higher order diffraction lights reflect at the wafer, reflect at the final surface of the projection optical system again, reach the wafer, and become the flare. Moreover, a zeroth-order light and first-order diffraction lights used for the exposure reflect at the wafer surface and the final surface of the projection optical system, and become the flare. An influence of the flare light increases according to a higher NA. Then, an exposure apparatus that has a light-shielding part to shield the flare light has been conventionally proposed. See, for example, Japanese Patent Applications, Publication Nos. 2003-107396 and 2001-264626. These exposure apparatuses can improve the line width control by the light-shielding part.

The immersion exposure apparatus adopts, usually, a step-and-scan manner, and relatively moves the final surface of the projection optical system and the wafer. Therefore, it is important to prevent a mixture of an air bubble into the liquid during movement of the final surface of the projection optical system and the wafer in the immersion exposure apparatus. The air bubble shields the exposure light, results in lowered transfer accuracy and yield, and cannot satisfy the demand for the high-quality exposure. If Japanese Patent Applications, Publication Nos. 2003-017396 and 2001-264626 are ordinarily applied to the immersion exposure, the light-shielding part becomes an influence that causes a mixture of the air bubble to the liquid, and the high-quality exposure cannot be achieved. In addition, the light-shielding part provided between the wafer and the projection optical system and a mechanism that supports and drives it intercept an optical path of a focal sensor for the wafer, or an arrangement of a focal detecting system is difficult in a usually dry system exposure apparatus. Here, the dry system exposure apparatus is an exposure apparatus that fills a region between the projection optical system and the object with air or a vacuum. Therefore, if a focal control is inadequate, the high-quality exposure cannot be executed.

### BRIEF SUMMARY OF THE INVENTION

Accordingly, the present invention is directed to a projection optical system and an exposure apparatus having the same, which can achieve a high-quality exposure and a high resolution.

A projection optical system according to one aspect of the present invention for projecting a pattern of a first object onto a second object includes a field stop provided to an optical element in the projection optical system, which is closest to the second object, the field stop provided for shielding the outside of a pattern projected area on the second object.

An exposure apparatus according to another aspect of the present invention includes the above projection optical system, wherein the exposure apparatus exposes a pattern of a mask as the first object onto an object as the second object through the projection optical system.

A device fabrication method according to another aspect of the present invention includes the steps of exposing an object using the above exposure apparatus, and performing a development process for the object to be exposed.

Other objects and further features of the present invention will become readily apparent from the following description of the preferred embodiments with reference to the accompanying drawings.

### BRIEF DESCRIPTION OF THE DRAWINGS

FIG. 1 is a schematic block diagram of an exposure apparatus as one aspect according to the present invention.

FIG. 2A is an enlarged view of a region near a final lens in a projection optical system of the exposure apparatus shown in FIG. 1, FIG. 2B is a plan view of a field stop shown in FIG. 2A, and FIG. 2C is an enlarged view of a region near a final lens as a variation of that shown in FIG. 2A.

FIGS. 3A to 3D are typical views for explaining a problem of a long-range flare.

FIGS. 4A to 4C are schematic sectional views of a region near a final lens as variations of that shown in FIG. 2A.

FIGS. 5A and 5B are schematic plan views for explaining a structure of the field stop shown in FIG. 2B.

FIGS. 6A and 6B are schematic sectional views of a region near a final lens as variations of that shown in FIG. 2A.

FIGS. 7A and 7B are schematic plan views of a field stop having an opening form.

FIGS. 8A and 8B are schematic sectional views of a final lens having the field stop shown in FIG. 7.

FIGS. 9A-9C are each schematic sectional views of a final lens according to another embodiment, having a curved surface.

FIG. 10 is a flowchart for explaining how to fabricate devices (such as semiconductor chips, such as ICs, LCDs, CCDs, and the like).

FIG. 11 is a detailed flowchart of a wafer process shown in Step 4 of FIG. 10.

### DETAILED DESCRIPTION OF THE PREFERRED EMBODIMENTS

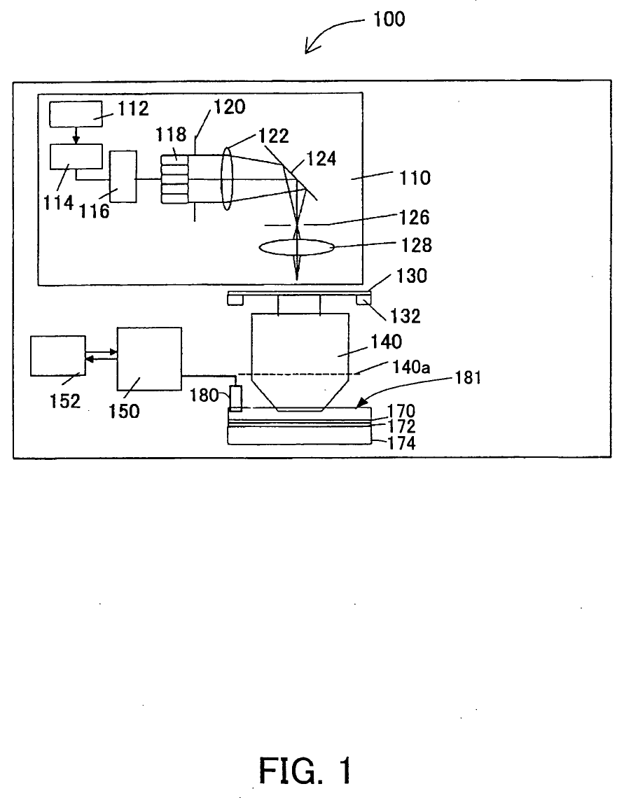

With reference to the accompanying drawings, a description will be given of an exposure apparatus 100 as one aspect according to the present invention. Here, FIG. 1 is a schematic block diagram of the exposure apparatus 100. The exposure apparatus 100 includes, as shown in FIG. 1, an illumination apparatus 110, a mask (reticle) 130, a mask stage 132, a projection optical system 140, a main controller unit 150, a monitor and input unit 152, a wafer 170, a retainer 172, a wafer stage 174, and a supply and recovery mechanism 180 that supplies and recovers a liquid 181 as an immersion material. The exposure apparatus 100 is an immersion type exposure apparatus that partially or entirely immerses the final surface of the final optical element in the projection optical system 140 at the wafer 170 side, and exposes a pattern on the mask 130 onto the wafer via the liquid 181. While the exposure apparatus 100 of the instant embodiment is a projection exposure apparatus in a step-and-scan manner, the present invention is applicable to a step-and-repeat manner and other exposure methods.

The illumination apparatus 110 illuminates the mask 130, on which a circuit pattern to be transferred is formed, and includes a light source section and an illumination optical system.

The light source section includes a laser 112 as a light source, and a beam shaping system 114. The laser 112 may use an ArF excimer laser with a wavelength of approximately 193 nm, a KrF excimer laser with a wavelength of approximately 248 nm, and an F₂ laser with a wavelength of approximately 157 nm, etc. A kind of the laser, the number of lasers, and a type of light source section are not limited.

The beam shaping system 114 can use, for example, a beam expander, etc., with a plurality of cylindrical lenses. The beam shaping system 114 converts an aspect ratio of the size of the sectional shape of a parallel beam from the laser 112 into a predetermined value (for example, by changing the sectional shape from a rectangle to a square), thus, reshaping the beam shape to a predetermined one. The beam shaping system 114 forms a beam that has a size and a divergent angle necessary for illuminating an optical integrator 118 to be described later.

The illumination optical system is an optical system that illuminates the mask 130. The illumination optical system includes a condenser optical system 116, the optical integrator 118, an aperture stop 120, a condenser lens 122, a deflecting mirror 124, a masking blade 126, and an imaging lens 128, in the instant embodiment. The illumination optical system can realize various illuminating modes, such as conventional illumination, annular illumination, quadrupole illumination, etc.

The condenser optical system 116 includes plural optical elements, and efficiently introduces a beam with the predetermined shape into the optical integrator 118. For example, the condenser optical system 116 includes a zoom lens system, and controls the shape and angular distribution of the incident beam to the optical integrator 118. The condenser optical system 116 includes an exposure dose regulator that can change an exposure does of light for illuminating the mask 130 per illumination.

The optical integrator 118 makes uniform illumination light that illuminates the mask 130, and includes a fly-eye lens in the instant embodiment for converting an angular distribution of incident light into a positional distribution, thus exiting the light. The fly-eye lens is so maintained that its incident plane and its exit plane are in a Fourier transformation relationship, and includes a multiplicity of rod lenses (or fine lens element). However, the optical integrator 118 usable for the present invention is not limited to the fly-eye lens, and can include an optical rod, a diffraction grating, plural pairs of cylindrical lens array plates that are arranged so that these pairs are orthogonal to each other, etc.

Right after the exit plane of the optical integrator 118 is provided the aperture stop 120 that has a fixed shape and diameter. The aperture stop 120 is arranged at a position approximately conjugate to the effective light source on a pupil 140a of the projection optical system 140, and the aperture shape of the aperture stop 120 corresponds to the effective light source shape on a pupil surface 142 in the projection optical system 140. The aperture shape of the aperture stop 120 defines a shape of the effective light source. Various aperture stops can be switched so that the stop is located on the optical path by a stop exchange mechanism (not shown) according to illumination conditions.

The condenser lens 122 collects all the beams that have exited from a secondary light source near the exit plane of the optical integrator 118 and passed through the aperture stop 120. The beams are reflected by the mirror 124, and uniformly illuminate or Koehler-illuminate the masking blade 126.

The masking blade 126 includes plural movable light shielding plates, and has an arbitrary opening corresponding to the effective area shape of the projection optical system 140. The light that has passed through the opening of the masking blade 126 is used as illumination light for the mask 130. The masking blade 126 is a stop having an automatically variable opening width, thus making a transfer area changeable. The exposure apparatus 100 may further include a scan blade, with a structure similar to the above masking blade 126, which makes the exposure changeable in the scan direction. The scan blade is also a stop having an automatically variable opening width, and is placed at an optically approximately conjugate position to the surface of the mask 130. Thus, the exposure apparatus can use these two variable blades to set the dimensions of the transfer area in accordance with the dimensions of an exposure shot.

The imaging lens 128 transfers an opening shape of the masking blade 126 onto the surface of the mask 130.

The mask 130 has a circuit pattern or a pattern to be transferred, and is supported and driven by the mask stage 132. Diffracted light emitted from the mask 130 passes the projection optical system 140, and then is projected onto the wafer 170. The wafer 170 is an object to be exposed, and a resist is coated thereon. The mask 130 and the wafer 170 are located in an optically conjugate relationship. The exposure apparatus 100 in the instant embodiment is a step-and-scan manner (i.e., a “scanner), and, therefore, scans the mask 130 and the wafer 170 to transfer the pattern on the mask 130 onto the wafer 170. When the exposure apparatus is a step-and-repeat manner (i.e., a “stepper”), the mask 130 and the wafer 170 are kept stationary for exposure.

The mask stage 132 supports the mask 130, and is connected to a transport mechanism (not shown). The mask stage 132 and the projection optical system 140 are installed on a lens barrel stool supported via a damper, for example, to a base frame placed on the floor. The mask stage 132 can use any structure known in the art. The transport mechanism (not shown) is made up of a linear motor, and the like, and drives the mask stage 132 in X-Y directions, thus moving the mask 130.

The projection optical system 140 serves to image the diffracted light that has been generated by the patterns formed on the mask 130 onto the wafer 170. The projection optical system 140 may use an optical system solely composed of a plurality of lens elements, an optical system composed of a plurality of lens elements and at least one concave mirror (a catadioptric optical system), and an optical system comprised of a plurality of lens elements and at least one diffractive optical element such as a kinoform, and a full mirror type optical system, and so on. Any necessary correction of the chromatic aberration is available through a plurality of lens units made from glass materials having different dispersion values (Abbe values), or arrange a diffractive optical element, such that it disperses in a direction opposite to that of the lens unit. Otherwise, the compensation of the chromatic aberration is done with narrowing of the spectral width of the laser.

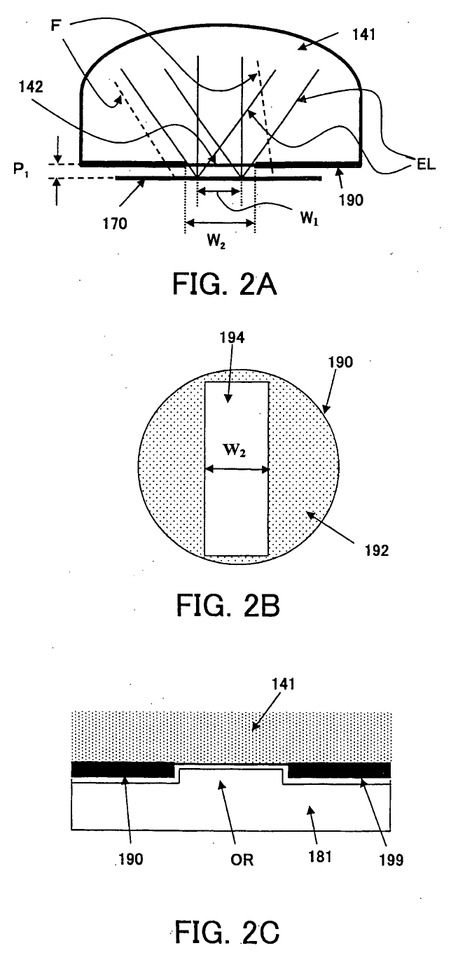

The optical element (final lens) 141 in the projection optical system 140, which is closest to the wafer 170, is shown in FIG. 2A. Here, FIG. 2A is a schematic enlarged sectional view of a region near the lens 141. A field stop 190 to shield the outside of a pattern projected area (exposure slit area) on the wafer 170 at the exposure by a shielding part 192 is provided at the lens 141. In FIG. 2A, the area defined by a width W₁ is the exposure slit area for transferring the mask pattern.

The field stop 190 is formed of an almost disk shape by a light-shielding film, and includes, as shown in FIG. 2B, the shielding part 192, and an opening part 194. Here, FIG. 2B is a schematic view of the field stop 190. The shielding part 192 shields a flare light F, shown in FIG. 2A with a broken line, and prevents the flare light F from reaching the wafer 170. On the other hand, the opening part 194 opens the exposure slit area, and permits an exposure light EL, shown in FIG. 2A with a continuous line, to reach the wafer 170. Although the opening part 194 is a rectangle shape, it may be an arc shape and other shapes. A width W₂ of the opening part 194 is defined by the width W₁ of the exposure slit area, NA of the projection optical system 140, a distance D, between the image surface (wafer 170) and the field stop 190.

Since the width W₂ of the opening part 194 becomes large as the distance D₁ becomes large, the shield of the long range flare becomes a disadvantage. However, for example, when the optical system is an immersion optical system, the distance D₁ is about several mm at the maximum, and the flare light can be shaded by providing the field stop 190 to a final lens under surface 142. As disclosed in Japanese Patent Applications, Publication Nos. 2003-017396 and 2001-264626, the shield effect of the long range flare improves by closing the field lens 190 constituted apart from the lens 141 to the image surface. However, if the field stop is arranged in the immersion material, problems, such as generating of the air bubble and dissolution of impurities from the field lens, are caused.

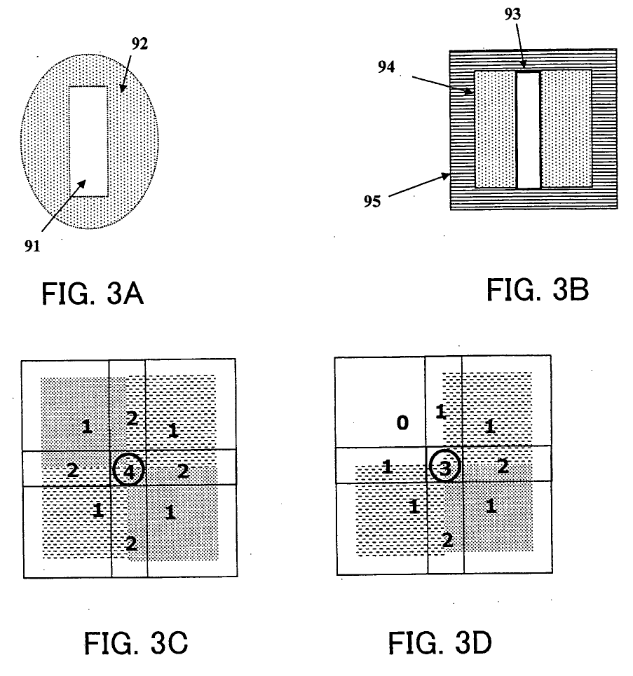

When the field stop 190 does not exist, the flare light F is incident upon the image surface (wafer 170) from the under surface 142 of the final lens 141, and becomes flare. An influence of the long range flare in the exposure apparatus with a step-and-scan manner is typically shown in FIGS. 3A to 3D. FIG. 3A shows the exposure slit area 91 and a distribution of the long range flare 92 in the stationary state. The long range flare shape is, generally, almost an ellipse shape, and a light intensity in a portion near a center part of the exposure slit area 91 is larger than a light intensity in a portion around it. The step-and-scan manner secures a necessary exposure area 94 (hereafter, a shot) by scanning the exposure slit area 93 in a lateral direction. In addition, an exposure position is stepwise so that each shot may not overlap, plural exposure is executed in a grid, and the entire wafer surface is processed. At this time, although the long range flare overlaps adjacent shots, the number of overlaps of the flare is different in positions in the shot as shown in FIG. 3C with the numeral. This overlap of the flare is changed from the flare distribution at the exposure of a single shot. The resist coated on the wafer as a photosensitive material is usually selected by integrating the light intensity, and the flares of the adjacent shots finally give the effect to the line width control. Moreover, as shown in FIG. 3D, in a single apparatus, all adjacent shots do not exist in a wafer circumference part. Therefore, a change of the flare distribution is different at each shot of the entire wafer. It is difficult to solve these problems by a change of the pattern or correction of the light intensity. Therefore, it is important that the long range flare becomes small and the necessary line width control amount is not exceeded.

The field stop 190 of the instant embodiment is not only uniting with the lens 141, but forms the same surface for the under surface 142 (in other words, the final surface of the projection optical system 140 is formed to be smooth). Therefore, the exposure apparatus 100 prevents the mix of the air bubble at the exposure, controls the line width control with high precision, and can provide the high-quality exposure. A step that cannot cause an involvement of the air depends on an inclination of the step and scanning speed, and at least 200 μm is permitted by the simulation. Therefore, this “same surface” permits the step or 100 μm or less. While controlling the generated air bubbles and to obtain enough shield effect of the long range flare, the under surface 142 of the lens 141 is formed to almost a plane surface, and the field stop 190 that has a thickness of 100 μm or less is formed on this. Materials that can be used for the shielding part 192 are Teflon®, etc.

The shielding part 192 and opening part 194 expose through the liquid in FIG. 2A. However, an antireflection film may be formed only on the opening part 194, or an antireflection film 199 may be on the entire surface including the shielding part 192 as shown in FIG. 2C, according to that which is necessary. Thereby, the antireflection film 199 can serve to prevent the shielding part 192 from contacting the liquid.

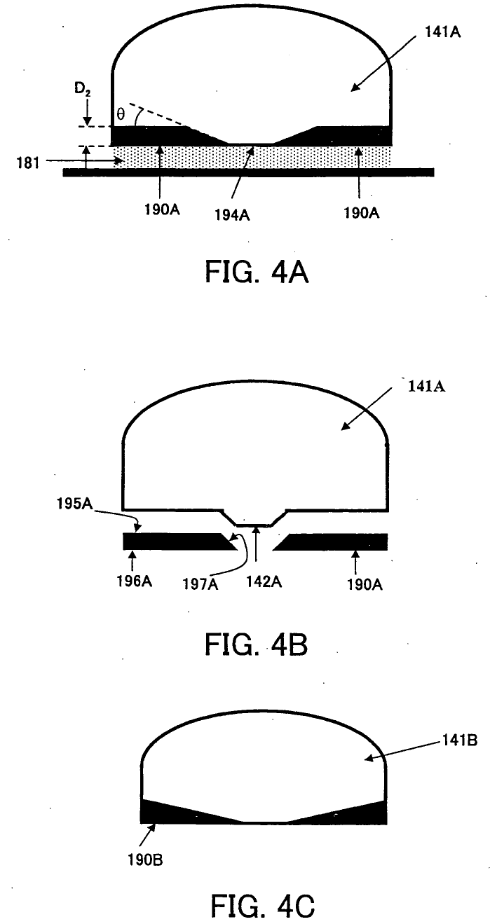

The shape of the final lens 141 and the field stop 190 is not limited to FIG. 2A. For example, the lens 141 and the field lens 190 can be replaced by a lens 141 having a concave section and a thicker field stop 190A. Here, FIG. 4A is a schematic enlarged sectional view of a region near the lens 141A. The instant embodiment processes the lens 141A according to the shape of the field stop 190A so that an under surface 196A of the field stop 190A and an under surface 142A of the lens 141A become the same surface.

A top surface 195A and the under surface 196A of the field stop 190A is, as shown in FIG. 4B, a plane, and has an inclination surface 197A to prevent a cut of an effective light for imaging the pattern of the mask 130. Here, FIG. 4B is a schematic decomposition sectional view of the lens 141A and the field stop 190 shown in FIG. 4A. By processing the lower part of the lens 191A according to the shape of the field stop 190A, the final surface of the projection optical system 140 is smoothly connected in a state combined and unified by both. Thereby, even if the lens 141 moves relative to the liquid 181, the exposure apparatus 100 can prevent generating and mixture of the air bubble. Here, “smooth” is defined by conditions without generation of the air bubble by the involvement, and the step of 100 μm, or less, may exist between the field stop 190A and the under surface 142A of the lens 141A. The long range flare can be shielded more effectively by projecting the shielding member for the under surface of the lens by only a permitted step amount.

Moreover, the top surface 195A of the field stop 190 does not need to be a plane, and may be a field stop 190B constituted by the entire top surface by an inclination surface as shown in FIG. 4C. If these have a necessary and an enough opening range on the under surface of the lens, and do not cut the effective light, they can be a selected arbitrary shape, in view of ease of processing as a standard. Here, FIG. 4C is a schematic enlarged view of a region near the lens 141B.

Moreover, the lens 141A and the under surface 196A of the field lens 190A is not limited to the plane, and may be a curved plane.

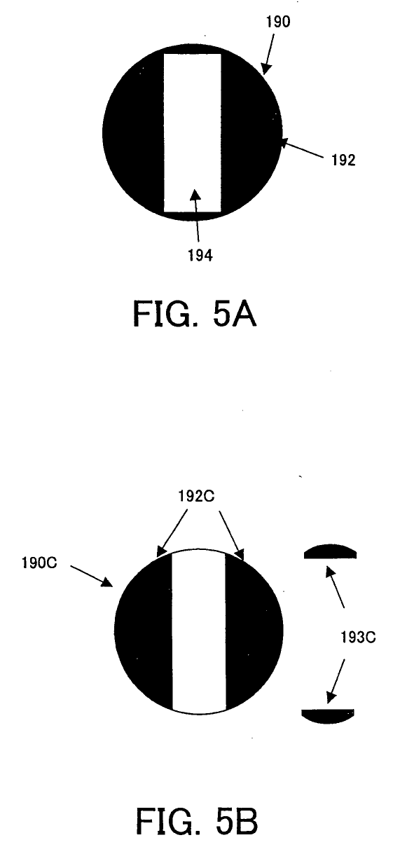

FIG. 5A is a schematic plan view of a field stop 190C similar to that shown in FIG. 2B. When the shape of the opening part 194 is a rectangle, an integral-type shielding part 192 removed by the necessary opening shape may be used, or the shielding part is divided into regions 192C and 193C, as shown in FIG. 5B, and may be combined. Since the opening part 194 has a condition that does not cut the light, a vertex part of the rectangle may have roundness. In FIG. 5B, the shielding part 192 is divided into the shielding part 192C contacted with a longitudinal part of the slit and the shielding part 193C contacted with a lateral part of the slit. Although a material that enables the structure of such a shielding part is ceramics, a polymer, etc., it is necessary to suitably select by the property of the immersion materials.

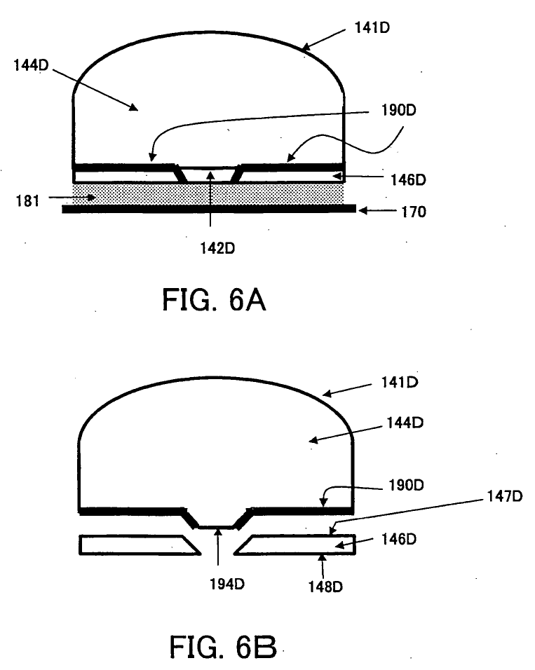

Materials of the lens 141 and field stop 190 contacted with the liquid 181 are selected so that the liquid 181 is not polluted. For example, if the liquid 181 is pure water, it is not desirable to use a metal film as the shielding part 182 and to expose through the liquid 181. Hereafter, referring to FIGS. 6A and 6B, a description will be given of a means to solve this problem though the material film is used as the shielding part 192. Here, FIG. 6A is a schematic enlarged sectional view of a region near a lens 141D, and FIG. 6B is a schematic decomposition section view of a laminated board 146D detached form the lens 141D shown in FIG. 6A.

The lens 141D has a structure combined of a lens body (optical part) 144D, a field stop 190D, and the laminated board 146D. An opening part 194D has a necessary size to secure the NA of the projection optical system. The laminated board 146D protects a shielding part of the field stop 190D, and does not contact with the liquid 181. Thus, the laminated board 146D modifies a limit for the material of the shielding part. Moreover, in the instant embodiment, the field stop 190D has a solid shape that a center of a disk lifts to a cone shape.

An under surface 142 of the lens body 144D and an under surface 148D of the laminated board 146D form the same surface, similar to the above embodiment. Actually, calcium fluoride is inferior to water resistance among the glass materials used for the ArF exposure apparatus, and at least a portion that contacts with the liquid is formed by synthetic quartz. A material of the laminated board 146D may be the same as that of the lens body 144D or may be different from the lens body 144D, and may be synthetic quartz. A thickness of the laminated board 146D does not have especially a limit, when the light-shielding film coats a side consisting of an inclination surface.

In the instant embodiment, the top surface 147D and under surface 148D of the laminated board 146 is a plane. However, the top surface 147D may be an inclination surface as above-mentioned with reference to FIGS. 4A to 4C. Moreover, the under surface 142D of the lens body 144D is set to a plane, the laminated board 146D is set to a plane-parallel plate, and the light-shielding film and the opening to pass through the effective light are installed in an interface.

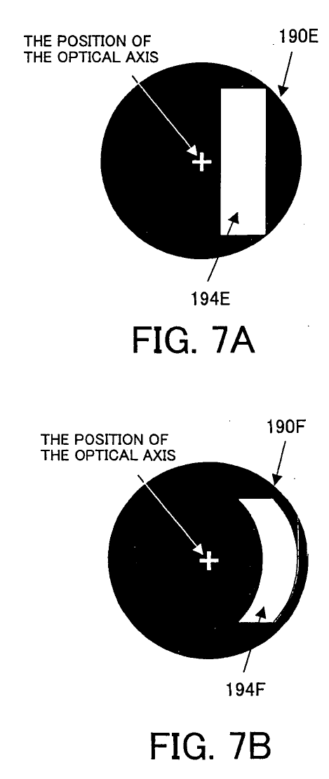

The above description assumes that an exposed area exists on an optical axis and is a rectangle, and the final surface is a plane. However, the exposure slit is shifted to an optical off-axis maintaining the exposure slit to a rectangle, or a range that corrects aberration is narrowed by being the exposure slit to an arc shape and a load of an optical system design is reduced, to achieve the higher NA required of the immersion projection optical system. In this case, the opening shape on the final surface needs to reflect these. FIG. 7A is a typical view of a field stop 190E having an opening shape that is needed in an off-axis rectangle, and FIG. 7B is a typical view of a field stop 190F having an opening shape that is needed in an arc. In FIGS. 7A and 7B, a center of the opening part 194E and 194F shifts from the optical axis position. The opening part 194E and 194F is determined based on the condition that does not cut the effective light similar to the case that the rectangle slit exists on the optical axis.

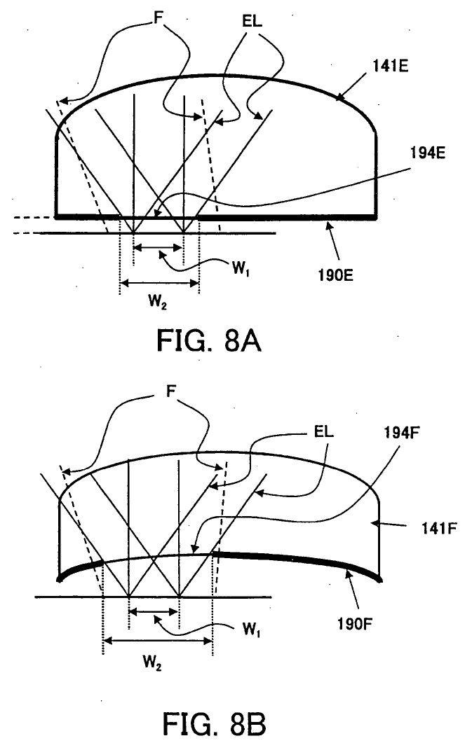

FIG. 8A is a sectional view of a final lens 141E and 141F having the field stop 190E and 190F shown in FIGS. 7A and 7B. Here, the field stop 190E and 190F and the final surface of the opening part 194E and 194 F form the flat same surface. FIG. 8A shows the same structure as that of FIG. 2A, which is an example when the slit exists on the optical axis, and can apply the structure that uses the light-shielding member or arranges the shading body inside the lens shown in FIGS. 4A to 6B.

There is a method of forming the final surface to a curved surface as a further effective means in the higher NA. This means especially demonstrates the effect, when using the immersion material that has a refractive index larger than the glass material of the final lens. The field stop 170F in this case may be provided so that the final surface of the opening part 194F and the field stop 190F forms a smooth same surface. The field lens 190F and final surface may have a step of 100 μm, or less, as above-mentioned.

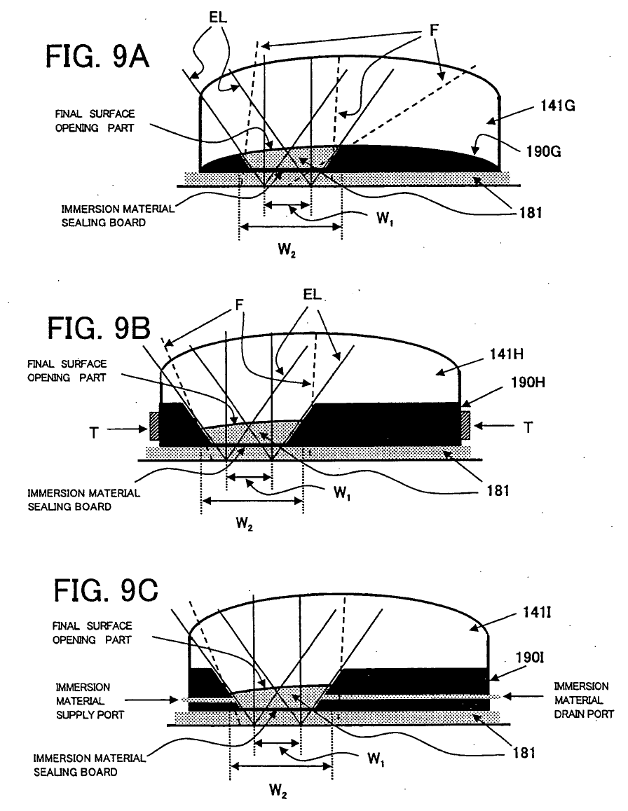

Moreover, another embodiment for forming a final lens 141G, 141H and 141I to a curved surface is shown in FIGS. 9A-9C. FIG. 9A is a structure that arranges a flat immersion sealing board (transparent plane-parallel plate) under the final surface, arranges a light-shielding member 190G in an outer part of the effective light between the final surface and the immersion sealing board, and seals the immersion material 181 to the effective light part. An under edge of the light-shielding member and the immersion sealing board forms the same surface, and controls the generation of the air bubble in the immersion material 181 filled between the immersion sealing board and the wafer by the involvement at the scanning exposure. The immersion material 181 sealed by the under edge of the light-shielding member and the immersion sealing board may be different from the immersion material 181 filled between the immersion sealing board and the wafer. By such a structure, the distance between the wafer and the light-shielding member can be shortened in view of reduction of the long range flare, the immersion material 181 does not need to introduce a convex shape, in view of the introduction of the immersion material 181, and the effect is demonstrated for each. The immersion sealing board preferably uses a synthesis quartz the same as the lens material. However, when using the immersion material 181 that has a high refractive index, a refractive index of the immersion material 181, and the NA is limited. Then, there is a method of using the lens material that has a further high refractive index by constituting the immersion sealing board as being exchangeable.

The shape of the light-shielding member 190G is not limited to the shape shown in FIG. 9A, and may be a shape which is easy to form under the condition that does not cut the effective light, similar to the case that the final surface is formed flat. In FIG. 9A, the immersion material 181 is sealed. However, since this position has high energy at the exposure, when the immersion material 181 with a large change of the refractive index to temperature is used or the durability is low, an optical problem is caused. Therefore, in FIG. 9B, the shape of the light-shielding member 190H changes, a temperature adjusting element T is installed, and the temperature of the sealed immersion material 181 is adjusted. Moreover, in FIG. 9C, a supply port and a drain port for the immersion material 181 is installed in the light-shielding member 190I, and the immersion material 181 surrounded by the immersion sealing board, light-shielding member 190I, and the final lens 141I becomes exchangeable. Therefore, the long range flare is reduced, and a performance of the immersion material with high refractive index is maximally utilizable by forming the final surface to be concave.

Returning to FIG. 1, the main control unit 150 controls driving of each component (for example, exposure control, supply, full and recover control of the liquid, and scanning driving control). Control information and other information for the main control unit 150 are indicated on the display of the monitor and input unit 152.

The wafer 170 is replaced with a liquid crystal plate and another object to be exposed in another embodiment. The photoresist is coated on a substrate. The wafer 170 is mounted on the wafer stage 174 via a holder 172, such as a wafer chuck. The holder 172 may use any holding method known in the art, such as vacuum holding and electrostatic holding, and a detailed description thereof will be omitted. The wafer stage 174 may use any structure known in the art, and preferably utilizes six-axis coax. For example, the wafer stage 174 uses a linear motor to move the wafer 170 in the X, Y and Z directions. The mask 130 and wafer 170 are, for example, scanned synchronously, and the positions of the mask stage 132 and the wafer stage 174 are monitored, for example, by a laser interferometer, and the like, so that both are driven at a constant speed ratio. The wafer stage 174 is installed on a stage stool supported on the floor, and the like, for example, via a damper. The mask stage 132 and the projection optical system 140 are installed on a barrel stool supported, via a damper, etc., on a base frame mounted on the floor.

The supply and recovery mechanism 180 serves not only to supply the liquid 181 to the space and to recover the liquid 181 from the space between the final surface of the projection optical system 140 and the wafer 170, but also to remove the gas or air bubble from the liquid 181. The supply and recovery mechanism is disclosed in Japanese Patent Application, Publication No. 2005-019864, and a detailed description thereof will be omitted.

The final surface of the projection optical system 140 closest to the wafer 170 is immersed in the liquid 181. A material selected for the liquid 181 has good transmittance to the wavelength of the exposure light, does not contaminate the projection optical system 140, and matches the resist process. The liquid 181 is, for example, pure water or a fluorine compound, and selected according to the resist coated on the wafer 170 and the wavelength of the exposure light. The coating of the last surface of the projection optical system 140 protects the final surface from the liquid 181.

In exposure, the liquid is continuously or intermittently supplied to the space between the surface of the wafer 170 and the lens 141 of the projection optical system 104 and is recovered from the space, a liquid surface (interface) of the liquid 181 is displaced, and the air bubble is removed. Then, the pattern formed on the mask 130 is projected on the wafer 170 through the projection optical system 140 and the liquid 181. The light emitted from the laser 112 is reshaped into a predetermined light shape by the beam shaping system 114, and then enters the illumination optical system. The condenser optical system 116 efficiently introduces the light to the optical integrator 118. At this time, an exposure dose adjusting part adjusts the exposure dose of the illumination light. The main control unit 150 selects an opening shape and a polarization state as an illumination condition suitable for the mask pattern. The optical integrator 118 makes the illumination light uniform, and the aperture stop 120 sets a predetermined effective light source shape. The illumination light illuminates the mask under optimal illumination conditions via the condenser lens 122, deflecting mirror 124, masking blade 126, and imaging lens 128.

The projection optical system 140 reduces at a predetermined magnification and projects onto the wafer 170 the light that passes the mask 130. The exposure apparatus in the step-and-scan manner fixes the laser 112 and the projection optical system 140, and synchronously scans the mask 130 and the wafer 170 to expose the entire shot. Then, the wafer stage 174 is stepped to the next shot for a new scan operation. This scan and step are repeated, and many shots are exposed on the wafer 170.

Since the final surface of the projection optical system 140 at the side of the wafer 170 is immersed in the liquid 181 that has a refractive index higher than that of the air, the projection optical system 140 has a higher NA and provides the higher resolution on the wafer 170. Moreover, the field stop 190 shades the flare light F, and secures the high precision line width control. The air bubbles are not generated or mixed into the liquid 181 by the arrangement of the lens 141 and the field stop 190, and high-quality exposure is secured. Thereby, the exposure apparatus 100 transfers the pattern to the resist with high precision, and provides a high-quality device, such as a semiconductor device, an LCD device, an image pick-up device (e.g., a CCD), and a thin-film magnetic head.

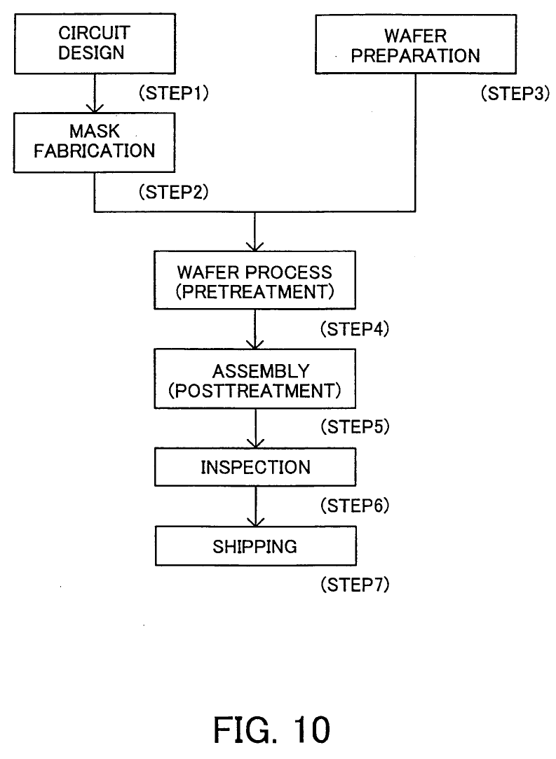

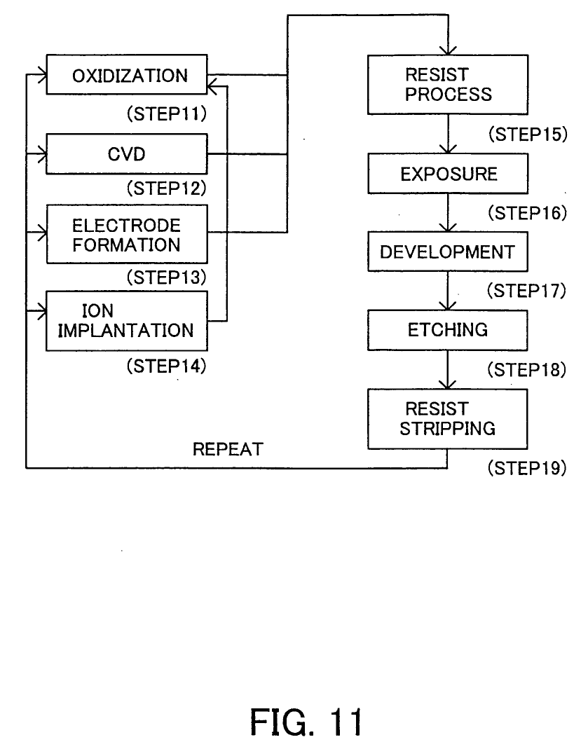

Referring now to FIGS. 10 and 11, a description will be given of an embodiment of a device fabrication method using the above-mentioned exposure apparatus 100. FIG. 10 is a flowchart for explaining how to fabricate devices (i.e., semiconductor chips, such as ICs and LSIs, LCDs, CCDs, and the like). Here, a description will be given of the fabrication of a semiconductor chip as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 11 is a detailed flow chart of the wafer process shown in Step 4 of FIG. 10. Step 11 (oxidation) oxidizes the wafer's surface. Step 12 (CVD) forms an insulating layer on the wafer's surface. Step 13 (electrode formation) forms electrodes on the wafer by vapor deposition, and the like. Step 14 (ion implantation) implants ions into the wafer. Step 15 (resist process) applies a photosensitive material onto the wafer. Step 16 (exposure) uses the exposure apparatus 100 to expose a circuit pattern from the mask onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device fabrication method of this embodiment may manufacture higher quality devices than the conventional ones. Thus, the device fabrication method using the exposure apparatus 100, and resultant devices, constitute one aspect of the present invention. Moreover, the present invention covers devices as intermediate and final products of the device fabrication method. Such devices include semiconductor chips, such as LSIs and VLSIs, CCDs, LCDs, magnetic sensors, thin-film magnetic heads, and the like.

The instant embodiment can prevent the long range flare from reaching the image surface by providing the field stop 190 near the image surface, and can provide a projection optical system that has a high precision line width control by preventing the involvement at the scanning and the generation of an air bubble in the immersion exposure. Although the instant embodiment explained an immersion exposure apparatus, the projection optical system of the present invention can be applied to an exposure apparatus with a dry system. In this case, since the field stop 190 is united with the lens 141, the exposure apparatus has an advantage that an optical path for the focal monitor, etc., is assured.

Furthermore, the present invention is not limited to these preferred embodiments and various variations and modifications may be made without departing from the scope of the present invention.

This application claims foreign priority benefit based on Japanese Patent Application No. 2005-033424, filed on Feb. 9, 2005, which is hereby incorporated by reference herein in its entirety as if fully set forth herein.

1. A projection optical system for projecting a pattern of a first object onto a second object, said projection optical system comprising:
a field stop provided to an optical element in the projection optical system, which is closest to the second object, said field stop being provided for shielding the outside of a pattern projected area on the second object.

2. A projection optical system according to claim 1, wherein said field stop includes a shielding part formed by a light-shielding film.

3. A projection optical system according to claim 1, wherein a final surface in the projection optical system, which is closest to the second object, is smooth or has a step of at most 100 μm.

4. A projection optical system according to claim 1, wherein said field stop has a thickness of at most 100 μm.

5. A projection optical system according to claim 1, wherein said optical element has a concave section.

6. A projection optical system according to claim 1, wherein said optical element has an inclination or a curved section at a side of the second object.

7. A projection optical system according to claim 1, wherein said field stop is provided inside of the optical element.

8. A projection optical system according to claims 1, wherein said optical element includes:
an optical part for projecting the pattern onto the second object; and
a laminated board, provided on the field stop, for preventing the optical element from exposing from a final surface in the projection optical system, which is closest to the second object.

9. A projection optical system according to claim 1, wherein said optical element includes:
an optical part for projecting the pattern onto the second object; and
an antireflection film for coating the optical part, and for coating the field stop so that the optical element does not expose from a final surface in the projection optical system, which is closest to the second object.

10. A projection optical system according to claim 1, wherein the optical element in the projection optical system, which is closest to the second object, has a curved final surface, said projection optical system further comprising a light-shielding member and a transparent plane-parallel plate so that the light-shielding member and the transparent plane-parallel plate can form the same plane.

11. A projection optical system according to claim 10, wherein a liquid is filled between the final surface and the light-shielding member, and between the final surface and the plane-parallel plate.

12. A projection optical system according to claim 11, further comprising a temperature controlling element provided to the light-shielding member.

13. A projection optical system according to claim 11, wherein said light-shielding member includes a liquid supply port and a liquid drain port.

14. An exposure apparatus comprising a projection optical system according to claim 1,
wherein said exposure apparatus exposes a pattern of a mask as the first object onto an object as the second object through the projection optical system.

15. An exposure apparatus according to claim 14, wherein said exposure apparatus exposes the object through a liquid between the object and the projection optical system, and the projection optical system.

16. A device fabrication method comprising the steps of:
exposing an object using an exposure apparatus according to claim 15; and
performing a development process for the object exposed.
